(19) United States
(12) Patent Application Publication
(10) Pub. No.: US 2025/0291614 A1
(43) Pub. Date: Sep. 18, 2025

(54) SYSTEMS AND METHODS FOR VIRTUAL ASSISTANT WITH EXPANSIVE MEMORY OVER MULTIPLE INTERACTIONS

(71) Applicant: WELLS FARGO BANK, N.A., San Francisco, CA (US)

(72) Inventors: Prakash Bhatta, San Francisco, CA (US); Rungson Samroengraja, San Francisco, CA (US)

(21) Appl. No.: 18/603,925

(22) Filed: Mar. 13, 2024

(51) Int. Cl. G06F 9/451

(52) U.S. Cl. CPC G06F 9/453

(57) ABSTRACT

A system includes a processing circuit configured to receive an input from a user device associated with a user during an interaction with a virtual assistant executed by the processing circuit. The processing circuit is further configured to determine a classification associated with the input, identify a prior user interaction with a virtual assistant associated with the classification, determine a prior resolution including an action available to the user based on the prior user interaction, determine if the action satisfies a threshold, and generate and provide an output corresponding to the prior resolution via the user device.

### TECHNICAL FIELD

The present disclosure relates generally to the analysis of an interaction between a user and a virtual assistant and providing resolutions of prior interactions of the user with the virtual assistant.

### BACKGROUND

When inquiring with a virtual assistant, people typically have difficulty remembering a prior resolution of a prior inquiry with the virtual assistant that may be similar to a resolution of the current inquiry.

### SUMMARY

Some arrangements relate to a system. In some arrangements, the system includes a processing circuit. In some arrangements, the processing circuit includes memory and one or more processors. In some arrangements, the processing circuit is configured to receive an input from a user device associated with a user during an interaction with a virtual assistant executed by the processing circuit, determine a classification associated with the input, identify a prior user interaction with a virtual assistant associated with the classification, determine a prior resolution based on the prior user interaction where the prior resolution comprises an action available to the user, determine if the action available to the user satisfies a threshold based on current financial data associated with the user and the prior resolution, generate and provide an output via the user device based on the action available to the user satisfying the threshold where the output corresponds to the prior resolution.

Some arrangements relate to a method. In some arrangements, the method is performed by a processing circuit and includes receiving an input from a user device associated with a user during an interaction with a virtual assistant executed by the processing circuit, determining a classification associated with the input, identifying a prior user interaction with a virtual assistant associated with the classification, determining a prior resolution based on the prior user interaction where the prior resolution comprises an action available to the user, determining if the action available to the user satisfies a threshold based on current financial data associated with the user and the prior resolution, and generating and providing an output via the user device based on the action available to the user satisfying the threshold where the output corresponds to the prior resolution.

Some arrangements relate to a computer-readable storage medium (CRM) having instructions stored thereon that, when executed by a processing circuit, cause the processing circuit to perform operations. In some arrangements, the operations include receiving an input from a user device associated with a user during an interaction with a virtual assistant executed by the at least one processing circuit, determining a classification associated with the input, identifying a prior user interaction with a virtual assistant associated with the classification, determining a prior resolution based on the prior user interaction where the prior resolution comprises an action available to the user, determining if the action available to the user satisfies a threshold based on current financial data associated with the user and the prior resolution, and generating and providing an output via the user device based on the action available to the user satisfying the threshold where the output corresponds to the prior resolution.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

FIG. 1 is a block diagram of a computing environment including a virtual assistant system, according to example embodiments.

FIG. 2 is a block diagram illustrating an example computing system suitable for use in the example embodiments described herein.

FIG. 3 is a flow diagram of a method for displaying prior resolutions of prior user interactions that correspond with an interaction between a user and a virtual assistant, according to example embodiments.

FIG. 4 is an illustration of a configuration of a user interface generated by the virtual assistant system of FIG. 1, according to example embodiments.

FIG. 5 is an illustration of an additional configuration of a user interface generated by the virtual assistant system of FIG. 1, according to example embodiments.

FIG. 6 is an illustration of an additional configuration of a user interface generated by the virtual assistant system of FIG. 1, according to example embodiments.

FIG. 7 is an illustration of an additional configuration of a user interface generated by the virtual assistant system of FIG. 1, according to example embodiments.

FIG. 8 is an illustration of an additional configuration of a user interface generated by the virtual assistant system of FIG. 1, according to example embodiments.

### DETAILED DESCRIPTION

Referring generally to the figures, systems for analyzing an interaction (e.g., a conversation, a current conversation, etc.) between a user and a virtual assistant executed by a processing circuit to determine if a virtual assistant conducted a prior user interaction (e.g., a prior interaction, etc.) related to the interaction are disclosed according to various embodiments herein, such that the system may provide the user with a prior resolution based on the prior user interaction during the interaction. Additionally, in some instances, the system determines a classification (e.g., an interaction classification, a conversation classification, etc.) associated with an input from a user device associated with the user during the interaction and determines that the prior user interaction is related to the interaction based on the prior user interaction also being associated with the classification.

In some instances, the system compares the prior resolution with a financial situation (e.g., a current financial situation, based on financial data of the user, etc.) of the user in order to determine if the prior resolution is currently appropriate (e.g., currently relevant, currently recommended, etc.) based on any changes in the financial situation (e.g., between a prior financial situation and the current financial situation, etc.) of the user between the prior user interaction and the interaction. For example, in some instances, the system may use financial data associated with the user and the prior resolution to determine if the action available to the user of the prior resolution is currently appropriate to the user. If the action of the prior resolution is currently appropriate to the user, the system may provide an output to the user device of the user corresponding to the prior resolution. If the action of the prior resolution is not currently appropriate to the user, the system may generate a recommended resolution based on the input from user device associated with the user and the current financial data of the user that includes a recommended action available to the user and provide a recommendation output to the user device of the user corresponding to the recommended resolution.

In some instances, the system determines prior decision components used to generate the prior resolution of the prior user interaction. For example, in some instances, the system may use data associated with the prior user interaction to determine reasons that the virtual assistant reached the prior resolution. The system provides the prior decision components to the user, such that the user may consider the prior decision components that were used by the virtual assistant to determine the prior resolution when considering if the prior resolution is still valid.

In some instances, the system determines an interaction frequency associated with interactions between the virtual assistant and the user that belong to the classification. For example, in some instances, the system may use data associated with the prior user interactions to determine a frequency of interactions between the virtual assistant and the user that discuss the same topic. The system may then use the interaction frequency to determine when a future interaction belonging to the classification will occur and provide a notification to the user corresponding to the classification before the future interaction occurs.

In some instances, the system may make a decision adjustment to one of the prior decision components of the prior resolution based on an input of the user to determine an updated resolution. For example, in some instances, the system may make adjustments to the reasoning behind the prior resolution in order to determine how the prior resolution may be changed due to the adjustments to the reasoning behind the prior decision. The system may then provide the updated resolution to the user so that the user can compare the prior resolution to the updated resolution to see the effect of the decision adjustment.

Accordingly, the systems and methods described herein provide a variety of improvements over conventional virtual assistant systems. For example, conventional virtual assistant systems have not been configured to monitor an interaction between a user and a virtual assistant and interjecting to provide a prior resolution to a prior user interaction between the user and the virtual assistant when the interaction is similar to the prior user interaction. Additionally, conventional virtual assistant systems have not been configured to provide the user with any reasoning that the user or the virtual assistant used during the prior user interaction to reach the prior resolution. As such, a person may repeatedly have similar interactions with a virtual assistant without being able to remember previous resolutions to each of previous conversation, resulting in a processing circuit executing the virtual assistant utilizing process power during each of the interactions. Further, even if the person remembered the previous resolutions to each of the previous interactions, the person may have difficulty remembering the reasoning used by the person or the virtual assistant to reach the previous resolutions. As such, the person may continue to query the virtual assistant regarding the reasoning used by the person or the virtual assistant, prolonging the interaction between the person and the virtual assistant which may result in the processing circuit utilizing additional processing power during the interaction or consuming additional bandwidth on a network used by the processing circuit during the interaction to communicate with the person.

The systems described herein solve these issues by providing users with prior resolutions of prior interactions between the users and a virtual assistant during interactions between the users and the virtual assistant executed by the processing circuit that are relevant to the prior user interactions, such that the processing circuit may utilize less processing power by not repeating processing performed during the prior interactions. In some instances, the prior resolutions may be provided to the user if an input from a user device associated with the user during the interaction is associated with a classification that is also associated with the prior user interaction. Providing the user with prior resolutions to prior user interactions may end the interaction between the user and virtual assistant when the prior resolutions solve an issue relating to the interaction such that the processing circuit may reallocate processing power utilized during the interaction and may free up bandwidth on a network used by the processing circuit during the interaction. In some instances, the prior resolution is also compared to the recommended resolution that is determined based on the financial data of the user in order to determine if the prior resolution still holds true for the user. In some instances, the prior decision components associated with the prior resolution may be provided to the user so that the user can analyze the reasons that the user and the virtual assistant reached the prior resolution of the prior user interaction in order to determine if the prior resolution still holds true. By providing the user with the prior decision components, the virtual assistant receives fewer queries for additional information, allowing the processing circuit to reallocate processing power that may have otherwise been used to answer the additional queries. Additionally, decision adjustments may be made to the decision components in order to determine updated resolutions so that the users can see how changes in factors that lead to the prior resolution may affect the prior resolution. As a result, the user may make future determinations regarding the prior resolutions, which may reduce a number of future interactions between the user and the virtual assistant and reduce the amount of processing power and network bandwidth utilized by the processing circuit in the future.

Before turning to the figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

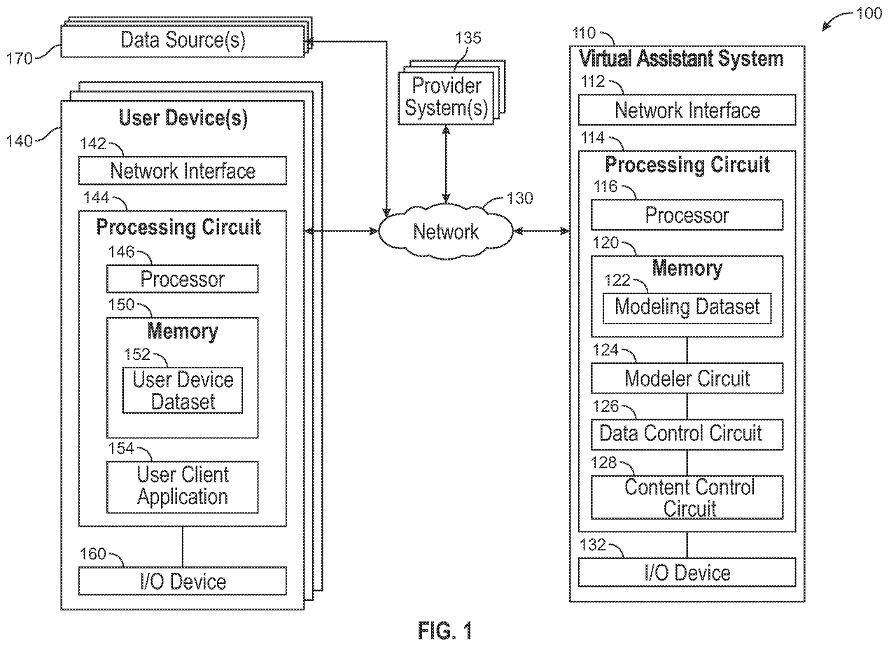

Referring to FIG. 1, a block diagram of a computing environment 100 including a virtual assistant system 110 is shown, according to potential embodiments. The virtual assistant system 110 can be controlled by, managed by, owned by, and/or otherwise associated with a provider, such as a service provider, bank, credit union, appraiser, health care institution, government institution, credit card company, insurance institution, or financial institution (FI). The computing environment 100 further includes one or more user devices (e.g., user device 140), one or more data sources (e.g., data source 170), and one or more provider systems (e.g., the provider system 135). In some instances, the virtual assistant system 110 is associated with the provider of the provider system 135. In other instances, the virtual assistant system 110 is not associated with the provider of the provider system 135 (e.g., an external provider, etc.) In some embodiments, the virtual assistant system 110, user device 140, and data source 170 are communicatively coupled. The various components of the computing environment are in communication with each other and are connected by a network 130. As used herein, “virtual assistant” is used to refer to refer to a system configured to communicate with a user during an interaction (e.g., a conversation, etc.), such as a chat bot, and perform automated tasks for the user. The virtual assistant may communicate with the user through a user device of the user. The communication between the virtual assistant and the user may be text based, audio based, or based on any other forms of communication.

Although the various systems and devices are shown in FIG. 1 as being singular, it will be understood that, in some instances, the computing environment 100 includes one or multiple of any of the various illustrated systems and/or devices, as desired for a given application. Similarly, while the following descriptions of the various systems and devices are largely provided in terms of single systems or devices, it will be appreciated that these descriptions are similarly applicable to any additional corresponding systems and/or devices (e.g., additional of the provider systems 135, additional of the user devices 140, and so on).

The virtual assistant system 110 may be operated by a provider, such as an entity, a consultant, a retailer, a service provider, and so on. The virtual assistant system 110 includes a network interface 112 that connects the virtual assistant system 110 to the network 130. The network interface 112 facilitates secure communications between the virtual assistant system 110 and various other components of the computing environment 100. The network interface 112 also facilitates communication with other entities (e.g., provider systems 135, etc.), such as other banks, healthcare systems, and so on. Further, in some arrangements, the network interface 112 includes cryptography capabilities to establish a secure or relatively secure communication session in which data communicated over the session is encrypted. The virtual assistant system 110 includes at least one of the processing circuits 114 (e.g., at least one processing circuit, etc.).

The processing circuit 114 includes a processor 116, a memory 120, a modeler circuit 124, a data control circuit 126, and a content control circuit 128. In other embodiments, the processing circuit 114 may contain more or less components than are shown in FIG. 1. The processor 116 may be implemented as one or more application specific integrated circuits (ASICs), field programmable gate arrays (FPGAs), a group of processing components, or other suitable electronic processing components. The memory 120 may be a device for storing data and/or computer code. The memory 120 may store data associated with a variety of application programs ran by the virtual assistant system 110. One such application may be to provide data to the modeler circuit 124, data control circuit 126, and content control circuit 128. The memory 120 can store a variety of data related to the modeler circuit 124 in a modeling dataset 122, which may be used by the modeler circuit 124 as discussed herein.

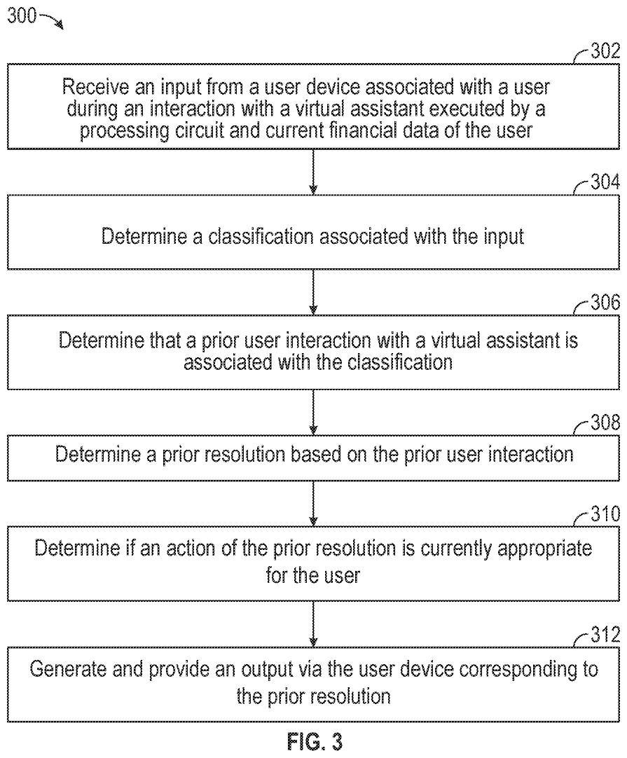

The modeler circuit 124 is structured or configured to perform a variety of the functionalities described herein. As will be described in detail below, with regard to FIG. 3, the modeler circuit 124 is configured to determine a prior resolution to a prior user interaction (e.g., a past conversation, etc.) between a user and a virtual assistant that corresponds with an interaction (e.g., a current conversation, etc.) between the virtual assistant executed by the processing circuit 114 and the user. In some instances, the prior user interaction is between the user and the virtual assistant executed by the processing circuit 114. In other instances, the prior user interaction is between the user and a virtual assistant executed by the provider of the virtual assistant system 110. For example, the virtual assistant executed by the provider of the virtual assistant system 110 could be a previous virtual assistant previously executed by the provider or a different virtual assistant executed by the provider. In still other instances, the prior user interaction is between the user and a virtual assistant executed by an external provider of the provider system 135.

In some instances, the modeler circuit 124 is configured to determine a classification associated with an input from a user device of the user during the interaction and the prior user interaction may be associated with the classification. For example, the interaction between the virtual assistant and the user may relate to buying a house and the modeler circuit 124 may determine that the classification of the interaction is home buying. The modeler circuit 124 may then determine that that a prior user interaction between the virtual assistant and the user is associated with home buying and provide a prior resolution to the prior user interaction relating to buying a house to the user. In some instances, the modeler circuit 124 is further configured to initiate an action available to the user the user and is included in the prior resolution. For example, the prior resolution may be related to purchasing a car, an action associated with the prior resolution may be to purchase the car, and modeler circuit 124 may be configured to initiate the purchase of the car after receiving an input from the user device during the interaction.

As will similarly be described below, in some instances, the modeler circuit 124 is further configured to model current financial data of the user with the prior resolution to determine if the action available to the user is currently appropriate (e.g., currently relevant, currently recommended, etc.) to the user. For example, the modeler circuit 124 may compare the current financial data of the user and the prior resolution and determine that the action available to the user is currently appropriate to the user or is not currently appropriate for the user based on the current financial data of the user. For example, if the action available to the user is to purchase a house with a 20% down payment and the current financial data of the user indicates that the user is not able to put down the 20% down payment, the modeler circuit 124 may determine that the action is not currently appropriate for the user since the user cannot put down the 20% downpayment. If the action is not currently appropriate for the user, the modeler circuit 124 may generate a recommended resolution based on the current financial data of the user and the input received during the interaction that includes a recommended action available to the user. In some instances, the modeler circuit 124 may determine prior decision components used to generate the prior resolution and/or current decision components used to generate the recommended resolution. In some instances, the modeler circuit 124 may generate a comparison between at least one of the prior decision components and at least one of the current decision components.=The prior decision components and the current decision components may be provided to the user such that the user may understand how the prior resolution was generated and how the modeler circuit 124 generated the recommended resolution.

As will similarly be described below, in some instances, the modeler circuit 124 is further configured to determine an interaction frequency associated with interactions between the user and the virtual assistant that are associated with the classification of the interaction. For example, if the user and the virtual assistant have an interaction relating to paychecks every two weeks then the interaction frequency for the interaction associated with a paycheck classification is biweekly. In some instances, the modeler circuit 124 may determine an interaction period associated with the classification based on the input and the interaction frequency. For example, the interaction period may occur from a date of the input and a future date of a future interaction between the user and the virtual assistant associated with the conversation classification based on the interaction frequency, such that the virtual assistant can provide a notification corresponding to the future interaction prior to the user initiating the future interaction.

The data control circuit 126 is configured to fuse data, including operations to generate various data structures stored in the memory 120 and used by the various circuits described herein. The data control circuit 126 can also be configured to receive data from multiple sources (e.g., the data sources 170, the provider systems 135, the user devices 140, etc.) and aggregate the data into various data structures stored in the memory 120.

The content control circuit 128 is configured to generate content for outputting to users. The content can be selected from various resources (e.g., the modeler circuit 124, the data control circuit 126). In some embodiments, the content control circuit 128 can be structured to provide content to the user device 140 over the network 130, for display (e.g., via a graphical user interface (GUI) of the user device 140, etc.). In some instances, the content control circuit 128 can be structured to provide content to the user device 140 over the network 130, for audio output (e.g., via a speaker of the user device 140, etc.) The content can also include actionable items that the user may select or otherwise manipulate. The content can be selected from various resources (e.g., from the data control circuit 126, from the memory 120, etc.). For example, the actionable items may be a button on the GUI of the user device 140, a button of the user device 140, an audio response into a microphone of the user device 140, or any other input made by the user into the user device 140 (e.g., a motion input of the user of the user device 140, a input recorded by a camera of the user device 140, etc.).

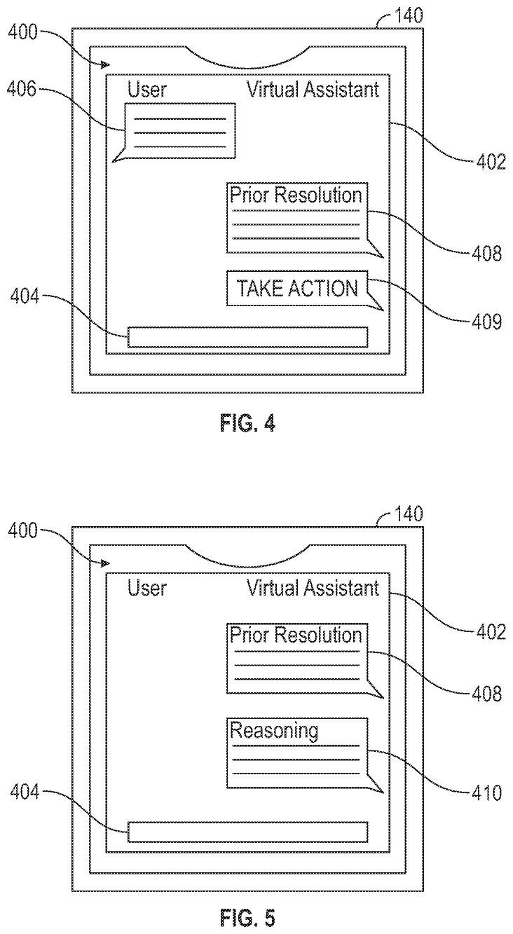

The content generated by the content control circuit 128 can include customized dashboards, such as those described in detail below, with reference to FIGS. 4-10. The content control circuit 128 can generate customized user-interactive dashboards for one or more entities, such as the user device 140, based on data received from the user device 140, data source 170, and/or any other computing device described therein. The generated dashboards can include various data (e.g., data stored in the content control circuit 128 and/or modeling dataset 122) associated with the interaction and/or the prior user interaction such as valuations, photographs or videos, descriptions, and/or others. In certain embodiments, the virtual assistant system 110 includes an application programming interface (API) and/or a software development kit (SDK) that facilitate the integration of other applications with the Virtual assistant system 110. For example, the virtual assistant system 110 is configured to utilize the functionality of the user device 140 interacting through an API.

The content control circuit 128 can generate an output corresponding to the interactions between the user and the virtual assistant. In some instances, the output may include correspond to the prior resolution of the prior user interactions (e.g., determined by the modeler circuit 124, etc.) between the user and the virtual assistant that is associated with the same classification as the interaction between the user and the virtual assistant. For example, the output may be a graphical interface that includes a chat box that corresponds to the interaction between the user and the virtual assistant and an element illustrating the prior resolution. In some instances, the output may include actionable items configured to allow the modeler circuit 124 to initiate the action corresponding to the prior resolution. For example, if the prior resolution were to consolidate several bank accounts of the user, the selection of one of the actionable items of the output may allow for the modeler circuit 124 to initiate the consolidation of the several bank accounts.

In some instances, the content control circuit 128 can generate a recommendation output associated with a recommended resolution (e.g., generated by the modeler circuit 124, etc.) of the interaction between the virtual assistant and the user. In some instances, the content control circuit 128 can generate a comparison output corresponding to the prior resolution (e.g., determined by the modeler circuit 124, etc.) and the recommended resolution (e.g., generated by the modeler circuit 124, etc.). The comparison output may include a comparison between a prior decision component of the prior resolution and a current decision component of the recommended resolution, such that the user may compare the prior decision component and the decision component and may understand differences between the prior resolution and the recommended resolution. In some instances, the content control circuit 128 can generate a notification output corresponding to a future interaction between the user and the virtual assistant before an occurrence of the future interaction. The notification output can include a notification associated with the future interaction such that the user may be reminded of the future interaction before the occurrence of the future interaction. In some instances, the content control circuit 128 can generate a logic output corresponding to one or more of the decision components of the prior resolution of the prior interaction between the user and the virtual assistant. For example, the logic output may include each item of information considered by the modeler circuit 124 when generating the prior resolution of the prior user interaction such that the user may consider each of the items of information and may understand how the modeler circuit 124 reached the prior resolution during the prior user interaction.

The input/output device 132 is structured to receive communications from and provide communications to users associated with the virtual assistant system 110. The input/output device 132 can be structured to exchange data, communications, instructions, etc. with an input/output component of the virtual assistant system 110 (e.g., a mouse, a monitor, a keyboard, a microphone, a speaker, etc.). As such, the input/output device 132 may provide an interface for the user to interact with various applications stored on the virtual assistant system 110.

The user device 140 is owned, operated, controlled, and/or otherwise associated with a person (e.g., a person looking to have an interaction with a virtual assistant, etc.). In some embodiments, the user device 140 may be or may include, for example, a desktop or laptop computer (e.g., a tablet computer), a smartphone, a wearable device (e.g., a smartwatch), a personal digital assistant, and/or any other suitable computing device. The user devices 140 may each include a network interface 142, a processing circuit 144, and an input/output device 160. The network interface 142, the processing circuit 144, and the input/output device 160 may be structured and function substantially similar to and include the same or similar components as the network interface 112, the processing circuit 114, and the input/output device 132 described above, with reference to the virtual assistant system 110. Therefore, it should be understood that the description of the network interface 112, the processing circuit 114, and the input/output device 132 of the virtual assistant system 110 provided above may be similarly applied to the network interface 142, the processing circuit 144, and the input/output device 160 of each of the user devices 140. The network interface 142 may similarly facilitate secure communications between the user device 140 and various other components of the computing environment 100. The processing circuit 144 similarly includes a memory 150 and a processor 146. The memory 150 and the processor 146 are substantially similar to the memory 120 and the processor 116 described above. Accordingly, the user devices 140 are similarly configured to run a variety of application programs and store associated data in a database of the memory 150. The variety of application programs and associated data may be stored as user device dataset 152.

Additionally, processing circuit 144 of each of the user devices 140 may each store, in the memory 150, and execute (“run”) user client applications 154, such as an Internet browser-presenting websites and/or applications provided or authorized by entities implementing or administering any of the computing systems in computing environment 100 to enable the user to perform or otherwise interact with various methods and operations described herein. For example, in some instances, the user client applications 154 comprise a provider client application (e.g., a financial institution banking application) provided by and at least partly supported by the virtual assistant system 110 and configured to enable various functionality described herein. In some instances, the user client applications 154 comprise a provider client application provided by and at least partly supported by the provider system 135 and configured to enable various functionality described herein.

In some instances, the user client application 154 is additionally coupled to various components within the computing environment 100 (e.g., the virtual assistant system 110, the provider system 135) via one or more application programming interfaces (APIs) and/or software development kits (SDKs) to integrate one or more features or services provided by the various components to enable the various methods and operations described herein. For example, in some instances, a provider client application provided to the user device 140 by the virtual assistant system 110 implements various functionality of the provider system 135 via one or more APIs and/or SDKs to allow for various functionality and/or information provided and/or stored by the provider system 135 to be utilized or otherwise implemented within the context of the provider client application.

Additionally, the user client application 154 is configured to output information to a display, a speaker, or another output (e.g., a tactile output, etc.) of user device 140 regarding information received from the virtual assistant system 110. For example, the user client application 154 is configured to communicate with a user interface to show graphics regarding content associated with interactions between the user and the virtual assistant such as a photograph, a video, or a description. As another example, the user client application 154 may be configured to communicate with a speaker to broadcast audio regarding content associate with interactions between the user and the virtual assistant. Further, a user response to a display of user device 140, a microphone of the user device 140, or another input of the user device 140 (e.g., a button of the user device 140, etc.) regarding information from the virtual assistant system 110 can send a message, task, or instruction to the virtual assistant system 110 via the network 130 that allows for the modeling dataset 122, modeler circuit 124, data control circuit 126, and/or content control circuit 128 to be perform an update.

The data sources 170 can provide data to the virtual assistant system 110 and/or user device 140. In some arrangements, the data sources 170 can be structured to collect data from other devices on network 130 (e.g., user devices 140 and/or other third-party devices) and relay the collected data to the virtual assistant system 110 and/or user device 140. In some embodiments, the virtual assistant system 110 may request data associated with specific data stored in the data source (e.g., data sources 170). For example, in some arrangements, the data sources 170 can support a search or discovery engine for Internet-connected devices. The search or discovery engine may provide data from other providers that, when used to update financial data associated with the user, will cause an update to the recommended resolution for the user (e.g., the recommended resolution generated by the modeler circuit 124 based on the current financial data of the user and the prior resolution of the prior user interaction, etc.). For example, the search or discovery engine may provide data from other providers indicating that an interest rate associated with a vehicle that the user discussed purchasing with the virtual assistant during the prior user interaction has decreased from 8% to 2%. The modeler circuit 124 may generate the recommended resolution for the user to purchase the vehicle based on the decrease in the interest rate associated with the vehicle. As another example, the search or discovery engine may provide data from sources that were not available during the prior user interaction.

With reference again to FIG. 1, the provider system 135 is controlled by, managed by, owned by, and/or otherwise associated with a provider, such as a bank, a credit union, an appraiser, a health care institution, a governmental institution, or other institutions (e.g., credit card companies, financial institutions (FI), insurance institutions, etc.). In some embodiment, the provider system may, for example, comprise one or more servers, each with one or more processing circuits including one or more processors configured to execute instructions stored in one or more memory devices, send and receive data stored in the one or more memory devices, and perform other operations to implement the operations described herein associated with certain logic and/or processes depicted in the figures. In some instances, the provider system 135 includes and/or has various other devices communicably coupled thereto, such as, for example, desktop or laptop computers (e.g., tablet computers), smartphones, wearable devices (e.g., smartwatches), and/or other suitable devices.

The provider system 135 may also store various individual information or financial data associated with the user. In some instances, the provider system is configured to retrieve and transmit various data stored within the provider system 135 to various components within the computing environment 100 to enable the various methods, functions, and processes described herein.

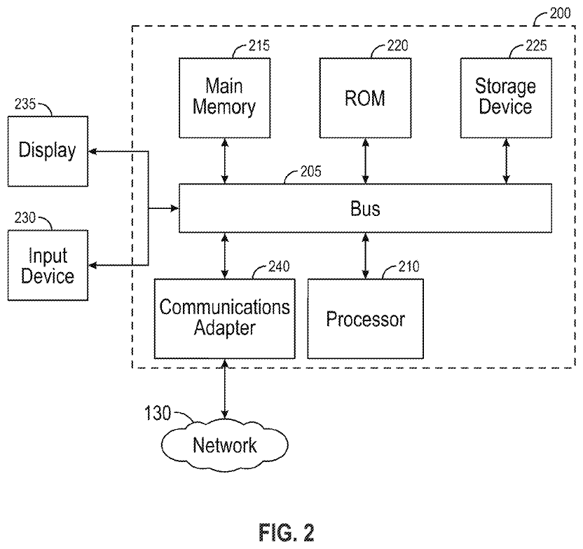

Referring now to FIG. 2, a depiction of a computing system 200 is shown. The computing system 200 can be used, for example, to implement the computing environment 100, the virtual assistant system 110, provider systems 135, user devices 140, data sources 170, and/or various other example systems described in the present disclosure. The computing system 200 includes a bus 205 or other communication component for communicating information and a processor 210 coupled to the bus 205 for processing information. The computing system 200 also includes main memory 215, such as a random-access memory (RAM) or other dynamic storage device, coupled to the bus 205 for storing information, and instructions to be executed by the processor 210. Main memory 215 can also be used for storing position information, temporary variables, or other intermediate information during execution of instructions by the processor 210. The computing system 200 may further include a read only memory (ROM) 220 or other static storage device coupled to the bus 205 for storing static information and instructions for the processor 210. A storage device 225, such as a solid-state device, magnetic disk, or optical disk, is coupled to the bus 205 for persistently storing information and instructions.

The computing system 200 may be coupled via the bus 205 to a display 235, such as a liquid crystal display, or active matrix display, for displaying information to a user. An input device 230, such as a keyboard including alphanumeric and other keys, may be coupled to the bus 205 for communicating information, and command selections to the processor 210. In some arrangements, the display 235 of the input device 230 has a touch screen. The input device 230 can include any type of biometric sensor, a cursor control, such as a mouse, a trackball, or cursor direction keys, for communicating direction information and command selections to the processor 210 and for controlling cursor movement on the display 235.

In some arrangements, the computing system 200 may include a communications adapter 240, such as a networking adapter. Communications adapter 240 may be coupled to bus 205 and may be configured to enable communications with the network 130 and/or other computing systems. In various illustrative arrangements, any type of networking configuration may be achieved using communications adapter 240, such as wired (e.g., via Ethernet), wireless (e.g., via Wi-Fi, Bluetooth), satellite (e.g., via GPS) pre-configured, ad-hoc, LAN, WAN.

According to various arrangements, the processes that effectuate illustrative arrangements that are described herein can be achieved by the computing system 200 in response to the processor 210 executing an arrangement of instructions contained in main memory 215. Such instructions can be read into main memory 215 from another computer-readable medium, such as the storage device 225. Execution of the arrangement of instructions contained in main memory 215 causes the computing system 200 to perform the illustrative processes described herein. One or more processors in a multi-processing arrangement may also be employed to execute the instructions contained in main memory 215. In alternative arrangements, hard-wired circuitry may be used in place of or in combination with software instructions to implement illustrative arrangements. Thus, arrangements are not limited to any specific combination of hardware circuitry and software.

Although an example processing system has been described in FIG. 2, arrangements of the subject matter and the functional operations described in this specification can be carried out using other types of digital electronic circuitry, or in computer software (e.g., application, blockchain, distributed ledger technology) embodied on a tangible medium, firmware, or hardware, including the structures disclosed in this specification and their structural equivalents, or in combinations of one or more of them. Arrangements of the subject matter described in this specification can be implemented as one or more computer programs, e.g., one or more subsystems of computer program instructions, encoded on one or more computer storage medium for execution by, or to control the operation of, data processing apparatus. Alternatively, or in addition, the program instructions can be encoded on an artificially generated propagated signal, e.g., a machine generated electrical, optical, or electromagnetic signal, which is generated to encode information for transmission to a suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory (e.g., a non-transitory computer-readable storage medium, etc.).

Although shown in the arrangements of FIG. 2 as singular, stand-alone devices, one of ordinary skill in the art will appreciate that, in some arrangements, the computing system 200 may include virtualized systems and/or system resources. For example, in some arrangements, the computing system 200 may be a virtual switch, virtual router, virtual host, or virtual server. In various arrangements, computing system 200 may share physical storage, hardware, and other resources with other virtual machines. In some arrangements, virtual resources of the network 130 (e.g., network 130 of FIG. 1) may include cloud computing resources such that a virtual resource may rely on distributed processing across more than one physical processor, distributed memory, etc.

As used herein, the term “resource” refers to a physical or virtualized (for example, in cloud computing environments) computing resource needed to execute computer-based operations. Examples of computing resources include computing equipment or devices (server, router, switch, etc.), storage, memory, executable (application, service, and the like), data file or data set (whether permanently stored or cached), and/or a combination thereof (for example, a set of computer-executable instructions stored in memory and executed by a processor, computer-readable media having data stored thereon, etc.).

With an example structure of the computing environment 100 being described above, example processes performable by the computing environment 100 (or components/systems thereof) will be described below. It should be appreciated that the following processes are provided as examples and are in no way meant to be limiting. Additionally, various method steps discussed herein may be performed in a different order or, in some instances, completely omitted. These variations have been contemplated and are within the scope of the present disclosure.

Referring now to FIG. 3, a flowchart for a method 300 of displaying prior resolutions of prior user interactions that correspond with an interaction between a user and a virtual assistant is shown, according to some embodiments. The virtual assistant system 110 can be configured to perform the method 300. Further, any computing device described herein can be configured to perform the method 300. The outputs of the method 300 may be provided by and/or accessible by the user client application 154 and the content control circuit 128, for example. The method 300 may be performed by the virtual assistant system 110 or the user device 140, described above pertaining to FIGS. 1 and 2. In some instances, the method 300 begins in response to receiving, by a user device (e.g., the user device 140) and/or through a user client application (e.g., the user client application 154) an input from a user device associated with a user during an interaction with a virtual assistant. The input can include text or audio inputted by the user into the user device that is part of the interaction between the user and the virtual assistant. For example, in some instances, a user may initiate an interaction analysis of the interaction through a user device (e.g., the user device 140) by inputting a word or phrase associated with a classification that is associated with at least one prior user interaction between the user and a virtual assistant. In some embodiments, the method 300 begins when the virtual assistant system 110 receives data via the network 130.

At step 302, the method 300 begins with the processing circuit (e.g., the virtual assistant system 110, etc.) receiving an input from a user device associated with a user during an interaction with a virtual assistant executed by the processing circuit and current financial data of the user. The input may be a set of words or phrases spoken or written inputted by the user into the user device during the interaction with the virtual assistant. For example, the input from the user device may be a spoken sentence associated with purchasing a house. In some instances, the input from the user device may include input data associated with the input. For example, in some instances, the user device 140 may pre-process the input to generate the input data before providing the input to the processing circuit. For example, if the input is a set of words spoken by the user of the user device during the interaction with the virtual assistant, the user device 140 may identify the set of words spoken by the user of the user device and may generate input data that includes the set of words spoken by the user (e.g., as text, in a format that can be processed by the processing circuit, etc.).

The current financial data of the user may correspond to a financial situation of the user. For example, the current financial data may include person identification information of the user (e.g., a name of the user, a date of birth of the user, a social security number of the user, an address of the user, a previous address of the user, etc.), credit account information of the user (e.g., a credit score of the user, credit card account information associated with the user, loans of the user, mortgage information of the user, payment histories associated with the credit accounts of the user, credit limits associated with the credit accounts of the user, a credit utilization of the user, a credit history of the user, etc.), a payment history of the user (e.g., late payments made by the user, delinquent payments associated with the user, missed payments associated with the user, accounts in collections associated with the user, etc.), credit inquires associated with the user (e.g., hard credit inquires associated with the user, soft credit inquires associated with the user, etc.), public records associated with the user (e.g., bankruptcies associated with the user, tax liens associated with the user, court-ordered payments associated with the user, etc.). The processing circuit 114 may receive the current financial data of the user from the user device 140 (e.g., from the user client application 154 of the user device 140, etc.) from the data source 170, from the provider system 135, etc.

At step 304, once the processing circuit has received the input from the user device associated with the user during the interaction with the virtual assistant executed by the processing circuit and the current financial data of the user, the processing circuit is configured to determine a classification associated with the input. The processing circuit may determine the classification associated with the input based on the input. The classification may be a topic associated with the input, a theme associated with the input, or any other classification that identifies information included in the input or an intention of the user based on the input. In some instances, the processing circuit may be configured to identify the words or phrases included in the input and determine the classification based on the words or phrases. For example, the processing circuit may be configured to identify that the input includes the phase “Should I purchase a television using cash or credit?” and may determine that the classification associated with the input is a “television purchase” based on the words “television” and “purchase” included the input.

In some instances, the processing circuit is configured to utilize input recognition techniques (e.g., a speech recognition program, a text recognition program, etc.) to identify the set of words or phrases included in the input. In some instances, the processing circuit is configured to equip the virtual assistant with natural language processing capabilities and a knowledge base to enable the virtual assistant to understand and respond to inputs associated with the user of the user device. For example, the processing circuit may identify the set of words or phrases included in the input based on an audio input of a voice of the user and may determine the classification based on the set of words or phrases identified in the audio input of the voice of the user. As another example, the processing circuit may identify the set of words or phrases included in the input based on the text included in the input from the user and may determine the classification based on the set of words or phrases identified in the text of the input from the user. As yet another example, the virtual assistant may be provided with predetermined scripts, frequently asked question databases, and/or machine learning capabilities to respond to the inputs associated with the user of the user device. In other instances, the processing circuit may receive the input and the input data including the words of the input from the user device and may determine the classification based on the input and the input data.

In some instances, the input includes all of the information required to determine the input associated with the input or the modeler circuit 124 may need to receive additional data from a different source (e.g., the provider system 135, the data source 170, etc.). For example, an input from a user device associated with a user may include sets of words or phrases that are known by the modeler circuit 124 and the modeler circuit 124 may generate the classification based on the set of words or phrases or the sets of words or phrases may be unknown by the modeler circuit 124 and the modeler circuit 124 may need to receive additional data from a different source (e.g., the provider system 135, the data source 170, etc.) to be able to generate the classification based on the set of words or phrases.

In some instances, the processing circuit may determine that the input from the user device during the interaction between the user and the virtual assistant is associated with multiple of the classifications. For example, the input of “Should I purchase a house or a vehicle with the money I have in my high yield savings account?” may be associated with a first of the classifications relating to a house purchase classification, a second of the classifications relating to a vehicle purchase classification, and a third of the classifications relating to a high yield savings account classification.

In some instances, the processing circuit is configured to determine that a first of the classifications associated with the input from the user device during the conversation takes precedence over a second of the classifications associated with the input due to the first of the classifications having a stronger association with the input than the second of the classification, a first word or phrase included in the input associated with the first of the classifications occurring with a higher frequency than a second word or phrase included in the input associated with the second of the classifications, a first tone associated with the first word or phrase included in the input associated with the first of the classifications being classified as having a higher stress level than a second tone associated with the second word or phrase included in the input associated with the second of the classifications, etc. For example, a first word or phrase included in the input may correspond to a vehicle purchase and a second word or phrase included in the input may correspond to a property purchase. The first word or phrase may occur at a higher frequency in the input than the second word or phrase. The processing circuitry may determine that for the input a vehicle classification takes precedence over a property classification due to the first word or phrase corresponding to the vehicle purchasing occurring at the higher frequency in the input than the second word or phrase corresponding to the property purchase.

At step 306, once the processing circuit has determined the classification associated with the input, the processing circuit is configured to determine that a prior user interaction with a virtual assistant is associated with the classification. For example, the processing circuit may compare the classification associated with the input of the interaction with conversation classifications associated with prior user conversations between the user and a virtual assistant (e.g., previous interactions, interactions that have already occurred, interactions that occurred during a prior time period, etc.) to determine if any of the classifications associated with the prior user interactions match the classification associated with the interaction with the virtual assistant executed by the processing circuit. As another example, the classification associated with the interaction may be investment advice and the processing circuit may determine that one of the prior user interactions between the user and a virtual assistant was also associated with investment advice.

In some instances, the prior user interaction is between the user and the virtual assistant executed by the processing circuit 114. In other instances, the prior user interaction is between the user and a virtual assistant executed by the provider of the virtual assistant system 110. For example, the virtual assistant executed by the provider of the virtual assistant system 110 could be a previous virtual assistant previously executed by the provider or a different virtual assistant executed by the provider. In still other instances, the prior user interaction is between the user and a virtual assistant executed by an external provider of the provider system 135. In some instances, the processing circuit is configured to receive data from a data source (e.g., the data source 170, etc.) that includes the prior user interactions and the classifications associated with the prior user interactions so that the processing circuit can determine if any of the classifications associated with any of the prior user interactions match the classification associated with the input from the user device during the interaction with the virtual assistant. For example, at the conclusion of the prior user interactions between the user and the virtual assistant, the processing circuit may have determined the classification associated with each of the prior user interactions and provided data corresponding to the prior user interactions and the associated classifications to the data source 170 so that the data source 170 can store the data for future interaction analysis by the processing circuit. The data corresponding to the prior user interaction and the associated classification provided to the data source 170 may be in a form that is easily retrievable by the processing circuit during future interaction analysis. In other instances, the processing circuit may receive data from a data source (e.g., the data source 170, etc.) that includes the prior user interactions between the user and the virtual assistant and may determine the classification associated with each of the prior user interactions in order to determine if the prior user interactions are associated with the same classification as the interaction between the virtual assistant and the user. In other instances, the processing circuit may receive data from a data source (e.g., the data source 170, etc.) that includes the prior user interaction and the processing circuit determines the classifications associated with the prior user interaction (e.g., using similar techniques to determining the classification associated with the input from the user device during the interaction, etc.) so that the processing circuit can determine if any of the classifications associated with the prior user interactions match the classification associated with the input from the user device during the interaction.

In some instances, the processing circuit is configured to determine that the virtual assistant conducted a prior user interaction with the user that is associated with each of the classifications associated with the input of the interaction between the user and the virtual assistant (e.g., when the input of the interaction is associated with multiple of the classifications, etc.). For example, if the input of the interaction is associated with a housing classification and a vehicle classification, then the processing circuit may determine that the virtual assistant conducted a prior user interaction with the user that is associated with each of the housing classification and the vehicle classification. In various instances, the processing circuit may determine that the virtual assistant conducted a prior user interaction with the user that is associated with one of the classifications associated with the input of the interaction between the user and the virtual assistant. For example, if the input of the interaction is associated with a savings classification and an interest classification, the processing circuit may determine that the virtual assistant conducted a prior user interaction with the user that is associated with the savings classification or the interest classification.

At step 308, once the processing circuit has determined that the prior user interaction with the virtual assistant is associated with the classification, the processing circuit is configured to determine a prior resolution based on the prior user interaction. The prior resolution may correspond to a conclusion of the prior user interaction. For example, for a prior user interaction between the user and the virtual assistant discusses if the user should apply for a credit card, the prior resolution may be the virtual assistant recommending that the user apply for the credit card or the user stating that they will apply for the credit card. In some instances, the prior resolution includes an action available to the user (e.g., an action that may be taken by the user, etc.). For example, if the prior user interaction corresponds to the user purchasing a car, the prior resolution may be that the user should purchase the car, and the action available to the user is the user purchasing the car by putting 35% of a payment down for the car.

In some instances, the processing circuit is configured to receive data from a data source (e.g., the data source 170, etc.) that includes the prior user interactions and the prior resolutions to the prior user interactions so that the processing circuit can determine the prior resolutions to the prior user interactions. For example, at the conclusion of the prior user interactions, the processing circuit may have determined a prior resolution of each of the prior user interactions and provided data corresponding to the prior user interactions and the prior resolutions of the prior user interactions to the data source 170 so that the data source 170 can store the data for future interaction analysis by the processing circuit. In other instances, the processing circuit may receive data from a data source (e.g., the data source 170, etc.) that includes the prior user interactions between the user and the virtual assistant and may determine the prior resolutions of the prior user interactions based on content of the prior user interaction.

In some instances, the processing circuit may determine that the prior user interactions conducted between the virtual assistant and the user include multiple of the prior resolutions. For example, the prior user interaction may have included a discussion relating to an opening of a savings account and an opening of a brokerage account. The prior user interaction may include a first of the prior resolutions relating to the opening of the savings account and a second of the prior resolutions relating to the opening of the brokerage account. Additionally, the prior user interaction may be associated with a first of the classifications relating to a savings account classification and a second of the classifications relating to a brokerage account classification.

At step 310, once the processing circuit has determined the prior resolution based on the prior user interaction, the processing circuit is configured to determine if the action of the prior resolution is currently appropriate for the user. In some instances, the processing circuit may determine if the action available to the user is currently appropriate to the user based on the current financial data of the user and the prior resolution based on the prior user interaction. For example, the processing circuit may model the action of the prior resolution with the current financial data of the user to determine if the action is currently appropriate to the user based on the current financial situation of the user. In some instances, the action may be currently appropriate to the user (e.g., if the current financial situation of the user has similarities to a previous financial situation of the user when the prior user interaction occurred, etc.) or the action may not be currently appropriate to the user (e.g., if the current financial situation of the user does not have similarities to the previous financial situation of the user when the prior user interaction occurred, etc.).

As used herein, “currently appropriate” is used to refer to a determination by the processing circuit if the action available to the user is beneficial or available to the user. For example, the processing circuit may determine an impact of the action available to the user on a financial well-being of the user and determine that the action is currently appropriate for the user if the impact is positive (e.g., results in raising a financial characteristic associated with the user, such as a net worth, credit score, savings account balance, expected investment returns, etc.) or determine that the action is not currently appropriate for the user if the impact is negative (e.g., results in lowering a financial characteristic associated with the user, such as a net worth, credit score, savings account balance, expected investment returns, etc.). In some embodiments, the processing circuit May determine an impact of the action available to the user on a financial well-being of the user and determine that the action is currently appropriate for the user if the impact has an effect on a financial characteristic associated with the user changing a particular amount in relation to a threshold (e.g., exceeding a threshold, changing a magnitude amount in relation to a threshold, remaining below a threshold, falling below a threshold, etc.). As another example, the processing circuit may determine that the action available to the user is currently appropriate for the user if it is possible for the user to complete the action or determine that the action is not currently appropriate for the user if it is impossible for the user to complete the action.

In some instances, the processing circuit may determine if the action available to the user is currently appropriate for the user based on financial rules and the financial data of the user. For example, the processing circuit may determine that an action available to the user of purchasing an expensive item is currently appropriate for the user if the financial data of the user indicates that the user has an emergency fund equal to six months of living expenses of the user or may determine that the action of purchasing the expensive item is not currently appropriate for the user if the financial data of the user indicates that the user does not have an emergency fund equal to six months of living expenses of the user. As another example, the processing circuit may determine that an action available to the user of renting an apartment is currently appropriate for the user if a rent of the apartment is less than 30% of an income of the user indicated by the financial data of the user or may determine that the action of renting the apartment is not currently appropriate for the user if the rent of the apartment is greater than 30% of the income of the user. As yet another example, the processing circuit may determine that an action available to the user of purchasing a vehicle is currently appropriate for the user if the financial data of the user indicates that any existing monthly debt payments of the user plus the monthly debt payment for the vehicle is less than 36% of an income of the user indicated by the financial data of the user or may determine that the action of purchasing the vehicle is not currently appropriate for the user if the existing monthly debt payments plus the monthly debt payment for the vehicle is greater than 36% of the income of the user.

In some instances, the processing circuit may determine if the action available to the user is currently appropriate for the user based on financial goals of the user. For example, the user may input financial goals into the user client application 154 and the processing circuit may compare the action available to the user to the financial goals and the financial data of the user to determine if the action is currently appropriate for the user or not financially appropriate for the user. For example, the user may input a budget for a spending category associated with the action available to the user and the processing circuit may determine that an action available to the user is currently appropriate for the user if the action does not result in the budget being surpassed or determine that the action available to the user is not currently for the user if the action results in the budget being surpassed.

In some instances, the processing circuit may determine if the action available to the user is currently appropriate for the user based on a risk associated with the action. For example, if a risk associated with an action available to the user is above a risk threshold (e.g., a risk threshold set by the user, a risk threshold rule set by the provider of the provider system 135, etc.), the processing circuit may determine that the action is not currently appropriate for the user based on the risk being above the risk threshold. If the risk associated with the action available to the user is below the risk threshold, the processing circuit may determine that the action is currently appropriate for the user based on the risk being below the risk threshold.

At step 132, once the processing circuit has determined if the action of the prior resolution is currently appropriate for the user, the processing circuit is configured to generate and provide an output via the user device corresponding to the prior resolution. In some instances, the processing circuit is configured to generate and provide the output corresponding to the prior resolution responsive to the action available to the user being currently appropriate for the user. In some instances, the output includes an interface. The processing circuit may provide the interface to a graphical user interface (GUI) of a user device (e.g., the user client application 154 of the user device 140, etc.). The interface may include elements (e.g., text, videos, images, buttons, etc.) indicating the prior resolution to the prior user interaction associated with the classification that is associated with the input from the user device during the interaction with the virtual assistant. For example, the elements may be text describing the prior resolution to the prior user interaction. In some instances, the processing circuit may be configured to provide the prior resolution to the prior user interaction during the interaction between the user and the virtual assistant. For example, the interface may be provided to the GUI of the user device such that the interface interjects during the interaction between the user and the virtual assistant to provide the prior resolution to the prior user interaction to the user of the user device. In some instances, the output generated and provided by the processing circuit may be an audio output configured to provide the prior resolution to the user audibly. For example, the processing circuit may provide the output to a different output of the user device 140 (e.g., a speaker of the user device 140, etc.).

In some instances, the interface includes an actionable item (e.g., a button, a slide, etc.) associated with the prior resolution. The user of the user device may select the actionable item associated with the prior resolution to initiate the action available to the user. For example, in some instances, the actionable item may allow for the processing circuit to initiate the action available to the user. For example, the actionable item may allow for the processing circuit to initiate the creation of a checking account for the user if the action available to the user was to create the checking account. As another example, the actionable item may allow for the processing circuit to initiate a purchase of a vehicle if the action available to the user was to purchase the vehicle.

In some instances, the processing circuit is configured to generate a recommended resolution based on the current financial data of the user and the input received from the user device during the interaction. In some instances, the processing circuit generates the recommended resolution responsive to the action available to the user not being currently appropriate for the user. The recommended resolution may include a recommended action available to the user. For example, the processing circuit may model the current financial data of the user with the input from the user device during the interaction to determine a recommended resolution that includes a recommended action available to the user that is currently recommended for the user. For example, the processing circuit may model the current financial data of the user that includes a credit score of the user with the input from the user device during the interaction relating to a purchase of a vehicle to generate a recommended resolution relating to applying for a vehicle loan for the purchase of the vehicle based on the credit score of the user being above a predetermined threshold. The recommended resolution may include the recommended action to apply for the vehicle loan for the purchase of the vehicle and the recommended action may be currently appropriate for the user based on the credit score of the user being above the predetermined threshold. As another example, the processing circuit may model the current financial data of the user that includes a net worth of the user with the input from the user device during the interaction relating to opening a high yield savings account to generate a recommended resolution relating to opening a high yield savings account based on the net worth of the user being above a predetermined threshold. The recommended resolution may include the recommended action to open the high yield savings account and transfer a portion of the net worth of the user into the high yield savings account and the recommended action may be currently appropriate for the user based on the net worth of the user being above the predetermined threshold.

In some instances, the process of modeling includes using techniques such as machine learning, statistical analysis, and pattern recognition to establish relationships between data and parameters and generate resulting data based on those relationships. As used herein, “modeling” can refer to the processing circuit determining, generating, comparing, and/or modeling. In some embodiments, modeling can begin with the selection of an appropriate model based on the data and the parameters. It should be understood that the term modeling herein encompasses a wide range of techniques and approaches aimed at understanding relationships within data. This could include anything from statistical methods and rule-based systems to machine learning algorithms, depending on the nature of the data. Thus, modeling involves selecting techniques based on the specific characteristics of the data, ensuring that the chosen method or methods accurately captures relationships.

In some instances, the model parameters are trained and optimized using the cleaned, classified, and linked data and parameters. This training process can include using algorithms to adjust the model parameters such that the error between the model's predictions and the actual outcomes is minimized. The modeling process can also include feature engineering, which is the process of creating new features or modifying existing ones to improve the model's power. For example, instead of modeling all of the financial data with the input to generate the recommended resolution, a feature that ignores portions of the financial data that are not related with the input might result in a more efficient model due to the fact that most of the financial data may not relate to the input.

Once one or more models or techniques are trained and/or optimized, the processing circuits can use the model to generate resultant data. The resultant data could be a mathematical representation, a decision tree, a set of rules, or any other structure that captures the relationships between different data points. Moreover, the modeling process can include various safeguards to ensure privacy and security of user data (e.g., anonymizing the data).

In some instances, the processing circuits uses rule-based systems to model the data and the parameters. Rule-based systems can be where predefined rules are created by the processing circuits (or domain experts) to infer outcomes based on given conditions. For example, if the financial data of the user is not substantially different from past financial data of the user at the time of the prior user interaction, a rule may state that the recommended resolution should be equivalent to the prior resolution and that any recommended actions of the recommended resolution should be equivalent to the action of the prior resolution. This rule can be applied to the process to limit the process to only modeling the data when the current financial data of the user has changed between the prior user interaction and the current interaction and limit modeling the data when the financial data of the user has not changed between the prior user interactions and the current interaction, which may save processing power utilized by the processing circuits.

In some instances, the processing circuit is configured to generate and provide a recommendation output via the user device. In some instances, the recommendation output corresponds to the recommended resolution. In some instances, the processing circuit may be configured to generate the recommendation output responsive to determining that a variation is present between the action of the prior resolution and the recommended action of the recommended resolution. For example, the action of the prior resolution may be to apply for a loan for a purchase of a property based on prior financial data of the user at the time of the prior conversation, but the recommended action of the recommended resolution may be to purchase the property with cash based on the financial data of the user at the time of the conversation. Based on the variation between the action of the prior resolution and the recommended action of the recommended resolution, the processing circuit may generate the recommendation output to provide the recommended resolution to the user such that the user may be aware of the recommended resolution that corresponds to the current financial data of the user at the time of the conversation instead of the prior resolution that corresponds to past financial data of the user that may no longer be relevant to the user. In some instances, the recommendation output may be an interface (e.g., a recommendation interface, etc.) provided to the GUI of the user device 140. The recommendation interface may include a recommended element (e.g., text, videos, images, buttons, etc.) associated with the recommended action of the recommended resolution. The recommended element may indicate the recommended resolution to the interaction. For example, the recommended element may be text describing the recommended resolution and the recommend action associated with the recommended resolution.

In some instances, to the interface of the recommendation output includes an actionable item associated with the recommended resolution. The user of the user device may select the actionable item associated with the recommended resolution to initiate the recommended action corresponding to the recommended resolution. For example, in some instances, responsive to a selection of the actionable item, the processing circuit may initiate the recommended action corresponding to the recommended resolution.

In some instances, the processing circuit is configured to determine prior decision components used to generate the prior resolution. Each of the prior decision components may have been utilized to generate the prior resolution during the prior user interaction. For example, in some instances, if the prior user interaction related to if the user should accept a job offer and the prior resolution was that the user should accept the job offer, the prior decision components used to generate the prior resolution may be a first salary associated with the job offer, a second salary associated with a current job, a first commute associated with the job offer, a second commute associated with the current job, etc. As another example, if the prior user interaction related to if the user should purchase a watch and the prior resolution was that the user should purchase the watch, the prior decision components used to generate the prior resolutions may be a value of an emergency fund of the user is above a predetermined threshold, a value of the watch is below a proportional threshold to a net worth of the user, a condition of a current watch of the user is below a predetermined threshold, etc.

In some instances, the processing circuit is configured to receive data from a data source (e.g., the data source 170, etc.) that includes the prior user interaction, the prior resolution, and the prior decision components used to generate the prior resolutions so that the processing circuit can determine the prior decision components used to generate the prior resolutions of the prior user interaction. For example, at the conclusion of the prior user interaction, the processing circuit may have determined a prior resolution of the prior conversation based on the prior decision components and provided data corresponding to the prior user interaction, the prior resolution, and the prior decision components to the data source 170 so that the data source 170 can store the data for future interaction analysis by the processing circuit. In other instances, the processing circuit may receive data from a data source (e.g., the data source 170, etc.) that includes the prior user interaction between the user and the virtual assistant and may determine the prior resolution and the prior decision components or may receive data from the data source that includes the prior user interaction and the prior resolution and may determine the prior decision components.

In some instances, the processing circuit is configured to generate and provide a logic output via the user device. The logic output may correspond to the prior resolution and at least one of the prior decision components. In some instances, the logic output includes an interface. The processing circuit may provide the interface of the logic output to a GUI of a user device (e.g., the user client application 154 of the user device 140, etc.). The interface of the logic output may include a decision element (e.g., text, an image, a video, etc.) correspond to at least one of the prior decision components used to generate the prior resolution. For example, the interface of the logic output may include a text summary of the at least one of the prior decision components. In various instances, the interface of the logic output may include a plurality of the decision elements each associated with one of the prior decision components used to generate the prior resolution. In some instances, the logic output generated and provided by the processing circuit may be an audio interface configured to provide the prior resolution to the user audibly.

Furthermore, in some instances, the decision elements indicating the prior decision components shown within the interface of the logic output provided to the GUI may be arranged within the interface of the logic output based on their estimated relevance to the user. For example, in some instances, the processing circuit is configured to estimate the most relevant and/or beneficial of the prior decision components for inclusion within the interface of the logic output using one or more machine learning models of the processing circuit. In some instances, the processing circuit may train the one or more machine learning models to identify the most relevant and/or beneficial of the prior decision components for inclusion using various training data. The training data may include historical actions taken by users associated with prior decision components, and corresponding user information (e.g., income level, geographic location, financial data, etc.) associated with those users. In some instances, the training data may be data compiled over time from a variety of users associated with the provider and stored within a database associated with the provider system 135.

Accordingly, once the one or more machine learning models have been trained, the processing circuit may apply the historical actions taken by users associated with prior decision components and various user information pertaining to the user to the one or more machine learning models to identify the most relevant and/or beneficial of the prior decision components for inclusion on the interface of the logic output provided to the GUI. The processing circuit may further arrange the decision elements indicating the prior decision components specifically according to their estimated relevance. For example, in some instances, the most relevant of the decision elements may be arranged in a top left corner of the interface of the logic output. The decision elements may be arranged in descending order of relevance from left to right and top to bottom within the interface of the logic output. In some instances, the processing circuit is configured to utilize various feedback information (e.g., actions taken by the user that correspond to one of the prior decision components, an actionable item corresponding to one of the prior decision components being selected by the user, etc.) received from the user (e.g., via the user device 140) to retrain or otherwise update the one or more machine learning models. Accordingly, in some instances, the processing circuit may rearrange the decision elements on the interface of the logic output based on the updated machine learning models and their associated outputs.

In some instances, the interface of the logic output includes an actionable item (e.g., a button, a slider, a wheel, etc.) associated with the at least one of the prior decision components used to generate the prior resolution. The processing circuit may determine a decision adjustment of the at least one of the decision components corresponding to the adjustment of the actionable item in response to receiving an indication of an adjustment of the actionable item. For example, in some instances, the actionable item may allow for the processing circuit to determine a decision adjustment to the at least one of the prior decision components that is proportional to the adjustment of the actionable item. For example, an adjustment of the actionable item by 100% may cause the processing circuit to determine that a decision adjustment of the at least one of the prior decision components associated with an amount in a bank account of $500 should change the amount in the bank account by $500 to $1000.

In some instances, after the processing circuit has determined the decision adjustment of the at least one of the decision components corresponding to the adjustment of the actionable item, the processing circuit is further configured to generate an updated resolution based on the decision adjustment. In some instances, the updated resolution includes an updated action available to the user. For example, the processing circuit may model the decision adjustment of the at least one of the decision components with the prior resolution to generate an updated resolution including an updated action available to the user. For example, if the prior decision component relates to a credit score of the user and the adjustment of the actionable item results in the description adjustment of the decision component from a first credit score of 670 to a second credit score of 770, then the processing circuit may model the decision component of the second credit score of 770 with the prior resolution to generate an updated resolution that relates to the decision component of the second credit score of 770 instead of the decision component of the first credit score of 670. The increase of the decision component from the first credit score of 670 to the second credit score of 770 may result in a variation between the prior resolution and the updated resolution. For example, if the user had the second credit score of 770 instead of the first credit score of 670 additional financing options may be available to the user corresponding to a purchase of a home by the user, which may result in the virtual assistant recommending the updated resolution that is different from the prior resolution.

In some instances, the processing circuit is configured to generate and provide an updated resolution output via the user device. The updated resolution output may correspond to the updated action of the updated resolution. In some instances, the updated resolution output may include an interface via the GUI of the user device. The interface of the updated resolution output may include an updated element associated with the updated action of the updated resolution. As a result, the user may visualize how modifications to the decision components associated with the prior resolution may result in different outcomes such that the user may target modifications to the decision components in their lives in order to be able to achieve the different outcomes other than the prior resolution.

In some instances, the processing circuit is configured to determine current decision components used to generate the recommended resolution. Each of the current decision components may have been utilized by the processing circuit to generate the recommended resolution based on the current financial data and the input. For example, in some instances, if the input related to if the user should open a college fund for a child of the user and the recommended resolution is that the user should open the college fund for the child of the user, the current decision components associated with the recommended resolution may be that an age of the child is within an age range, that interests of the child align with predetermined interests associated with college, that a tax break associated with opening the college fund is greater than other potential tax breaks, etc.

In some instances, the processing circuit is configured to generate a comparison between at least one of the prior decision components and at least one of the current decision components based on the prior decision components and the current decision components. The comparison may include similarities between the at least one of the prior decision components and the at least one of the current decision components.

In some instances, the processing circuit is configured to generate and provide a comparison output via the user device, The comparison output may correspond to the comparison between the at least one of the prior decision components and the at least one of the current decision components. In some instances, the comparison output includes a comparison interface corresponding to the comparison. The processing circuit may provide the comparison interface to a graphical user interface (GUI) of a user device (e.g., the user client application 154 of the user device 140, etc.). The comparison interface may include the comparison between the at least one of the prior decision components associated with the prior resolution and the at least one of the current decision components of the recommended resolution. For example, the comparison interface may include a first text summary of the at least one of the prior decision components and a second text summary of the at least one of the current decision components such that the user may compare how each of the prior resolution and the recommended resolution were generated. In some instances, the comparison output generated and provided by the processing circuit may be an audio comparison interface configured to provide the prior resolution and the recommended resolution to the user audibly.

In some instances, the processing circuit is configured to determine an interaction frequency associated with interactions between the user and the virtual assistant executed by the processing circuit and being associated with the classification. For example, the processing circuit may model the input with the prior user interaction to generate an interaction frequency associated with interactions between the user and the virtual assistant associated with the classification. For example, in some instances, the processing circuit may model the input with the prior user interactions to generate the interaction frequency based on an amount of time between the prior user interaction and the input. As another example, the processing circuit may model the input with one of the prior user interactions that occurred a month prior to the input to determine that the interaction frequency associated with the interactions between the user and the virtual assistant associated with the classification is a monthly frequency. In some instances, the processing circuit may model the input with multiple of the prior user interactions associated with the classification to determine the interaction frequency associated with the interactions between the user and the virtual assistant associated with the classification. For example, the processing circuit may model the input with multiple of the prior user interactions that occurred two weeks prior to the input, four weeks prior to the input, and six weeks prior to the input to determine that the interaction frequency associated with the interactions between the user and the virtual assistant associated with the classification is a bi-weekly frequency.

In some instances, the processing circuit is configured to determine an interaction period associated with a future interaction between the user and the virtual assistant associated with the classification that has not yet occurred. The interaction period associated with the future interaction may be determined based on the input and the interaction frequency. For example, if the input occurs on August 2^{nd} and the interaction frequency is monthly, then the interaction period associated with the future interaction may be September 2^{nd}. As another example, if the input occurs on February 13^{th} and the interaction frequency is bi-weekly, then the interaction period associated with the future interaction may be February 27^{th}.

In some instances, the interaction period may include a variation range based on the input and the prior user interactions. For example, if a first of the prior user interaction occurred 15 days prior to the input and a second of the prior user interactions occurred 28 days prior to the input, the interaction frequency may be bi-weekly with a variation range of one day. As a result, the interaction period associated with the future interaction may be between 13 and 15 days from the occurrence of the input.

In some instances, the processing circuit is configured to generate and provide a notification output via the user device. The notification output may correspond to a notification associated with the future interaction where the future interaction has not yet occurred. In some instances, the notification output includes a notification interface corresponding to the future conversation before the future conversation has occurred. The processing circuit may provide the notification interface to the GUI of the user device (e.g., the user client application 154 of the user device 140, etc.). The notification interface may include a notification associated with the future conversation. For example, the notification may include text prompting the user of the user device to initiate the future conversation associated with the conversation classification such that the user is reminded of the future conversation. As another reminder, the input and the prior conversations may relate to an inquiry by the user to the virtual assistant to verify if a paycheck has been deposited in an account associated with the user that occurs with a conversation frequency that is bi-weekly. The notification of the notification interface may include text prompting the user to initiate a future conversation relating to verifying if the paycheck has been deposited in the account or the notification may include a confirmation that the paycheck has been deposited in the account such that the user is not required to initiate the future conversation. In some instances, the notification output generated and provided by the processing circuit includes an audio notification interface configured to provide the notification to the user audibly.

In some instances, the notification interface includes an actionable item associated with the prior resolution. The user of the user device may select the actionable item associated with the prior resolution to initiate the action corresponding to the prior resolution within the interaction period. For example, in some instances, the actionable item may allow for the processing circuit to initiate the action corresponding to the prior resolution within the interaction period. For example, the actionable item may allow for the processing circuit to transfer an amount from a checking account to a savings account within the interaction period if the action corresponding to the prior resolution was to transfer the amount from the checking account to the savings account. As a result, a user may quickly initiate actions associated with prior resolutions of prior user interactions within interaction periods associated with interaction frequencies related to the prior user interactions, such that the user may repeatedly initiate the actions at regular frequencies based on their previous actions.

Referring now to FIG. 4, an illustration of a configuration of a user interface 400 on the user device 140 is shown. The user interface 400 may be presented within the user client application 154. In some embodiments, the user interface 400 is generated and provided by the content control circuit 128 and transmitted to the user device 140 to be displayed to a user.

As illustrated, the user interface 400 includes a virtual assistant interface 402, an input actionable item 404, a user input element 406, a prior resolution element 408, and a prior resolution actionable item 409. As illustrated, virtual assistant interface 402 may be a window (e.g., a program window, a display window, etc.) included in the user interface 400. The virtual assistant interface 402 may display an interaction between a user and a virtual assistant executed by a processing circuit on a GUI of a user device such that the user may be provided with the interaction between the user and the virtual assistant. In some instances, the virtual assistant interface 402 may only be displayed in a portion of the user interface 400. In other instances, the virtual assistant interface 402 is displayed across an entirety of the user interface 400.

The input actionable item 404 may indicate a portion of the virtual assistant interface 402 where the user of the user device 140 may enter inputs associated with the user during the interaction with the virtual assistant. As illustrated, the input actionable item 404 is a text box where the user may enter text to create the inputs during the contestation. For example, the user may select the input actionable item 404 and may type in text on a keyboard communicably coupled to the user devices 140 to create the input during the interaction. As another example, the user may select the input actionable item 404 and may speak a message that is provided to the user device 140 to create the input during the interaction.

The user input element 406 may indicate the inputs associated with the user during the interaction with the virtual assistant. As illustrated, the user input element 406 is a text box that corresponds with the input associated with the user during the interaction with the virtual assistant. In some instances, the user input element 406 may include figures indicating the inputs associated with the user, elements indicating the inputs associated with the user, etc. For example, the user input element 406 may include text corresponding to the input associated with the user and the user input element 406 may additionally be colored with a first color that is different from a second color associated with the prior resolution element 408 such that the user may easily distinguish between the user input element 406 and the prior resolution element 408. The user input element 406 may indicate a question from the user of the user device 140 to the virtual assistant or a portion of the interaction between the user and the virtual assistant.

The prior resolution element 408 may indicate a prior resolution to a prior user interaction associated with a classification that is the same as the classification of the input from the user in the interaction between the user and the virtual assistant. As illustrated, the prior resolution element 408 is a text box that corresponds with the prior resolution to the prior user interaction. In some instances, the prior resolution element 408 may include figures indicating the prior resolution to the prior user interaction, elements indicating the prior resolutions to the prior user interaction, etc. For example, the prior resolution element 408 may include text corresponding to the prior resolution to the prior user interaction that has the same classification as the input from the user during the interaction between the user and the virtual assistant. In some instances, the prior resolution element 408 indicating the prior resolution may be linked to the user input element 406 that corresponds with the input from the user in the interaction between the user and the virtual assistant that has the classification that is the same as the classification of the prior user interaction associated with the prior resolution. For example, an arrow may extend from the prior resolution element 408 to the user input element 406 to indicate that the input indicating the user input element 406 has the same classification as the prior user interaction associated with the prior resolution indicated by the prior resolution element 408.

The prior resolution actionable item 409 may be associated with the prior resolution to the prior user interaction associated with the prior resolution element 408. In some instances, the user may select the prior resolution actionable item 409 to initiate an action corresponding to the prior resolution associated with the prior resolution element 408. For example, in some instances, the prior resolution actionable item 409 may allow for the processing circuit to initiate a creation of a bank account when the prior resolution associated with the prior resolution element 408 is to create the bank account. As another example, in some instances, the prior resolution actionable item 409 may allow for the processing circuit to initiate an application for a credit card when the prior resolution associated with the prior resolution element 408 is to apply for the credit card.

Referring now to FIG. 5, an illustration of a configuration of the user interface 400 on the user device 140 is shown. As illustrated, the user interface 400 includes the virtual assistant interface 402, the input actionable item 404, the prior resolution element 408, and a prior decision element 410. The prior decision element 410 may indicate prior decision components associated with the prior resolution to the prior user interaction associated with the classification that is the same as the classification of the input from the user in the interaction between the user and the virtual assistant. As illustrated, the prior decision element 410 is a text box that corresponds to the prior decision components associated with the prior resolution to the prior user interaction. In some instances, the prior decision element 410 may include figures indicating the prior decision components of the prior resolution, elements indicating the prior decision components of the prior resolution, etc. For example, the prior decision element 410 may include text corresponding to reasoning that the virtual assistant or the user utilized to determine the prior resolution associated with the prior resolution element 408 during the prior user interaction. As another example, the prior decision element 410 may include information corresponding to prior financial data of the user during a prior time period of the prior user interaction that were utilized by the virtual assistant or the user to determine the prior resolution associated with the prior resolution element 408 during the prior user interaction and/or outside information (e.g., interest rates, inflation, etc.) that were utilized by the virtual assistant or the user to determine the prior resolution associated with the prior resolution element 408 during the prior user interaction.

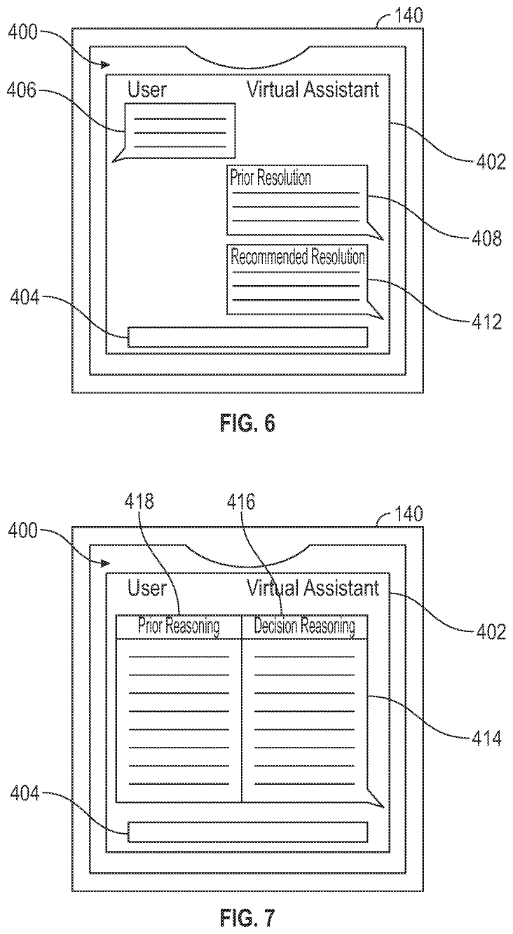

Referring now to FIG. 6, an illustration of a configuration of the user interface 400 on the user device 140 is shown. As illustrated, the user interface 400 includes the virtual assistant interface 402, the input actionable item 404, the user input element 406, the prior resolution element 408, and a recommended resolution element 412. The recommended resolution element 412 may indicate recommended actions of a recommended element generated by the processing circuit based on the input associated with the user during the interaction and current financial data of the user. As illustrated, the recommended resolution element 412 is a text box that corresponds to the recommended resolution generated based on the input associated with the user and the financial data of the user. In some instances, the recommended resolution element 412 may include figures indicating the recommended resolution, elements indicating the recommended resolution, etc. For example, the recommended resolution element 412 may include text corresponding to a recommended action of the recommended resolution for the user associated with the input associated with the user input element 406 such that the user may take the recommended action based on the input associated with the user and the financial data of the user.

Referring now to FIG. 7, an illustration of a configuration of the user interface 400 on the user device 140 is shown. As illustrated, the user interface 400 includes the virtual assistant interface 402, the input actionable item 404, and a comparison element 414. The comparison element 414 may indicate a comparison between the prior resolution of the prior user interaction and the recommended resolution generated based on the input associated with the user and the financial data of the user. As illustrated, the comparison element 414 is a T-chart that includes text corresponding to the prior resolution of the prior user interaction and the recommended resolution generated by the processing circuit. In some instances, the comparison element 414 may include figures comparing the prior resolution and the recommended resolution, elements comparing the prior resolution and the recommended resolution, etc. For example, the comparison element 414 may include text comparing the similarities and the differences between the prior resolution and the recommended resolution. As another example, if the interaction between the user and the virtual assistant is related to purchasing a car, the comparison element 414 may compare the prior resolution of taking out a loan to purchase the car with the recommended resolution of using cash to purchase the car (e.g., based on changes in the financial data of the user between the timing of the prior user interaction and the timing of the interaction, etc.).

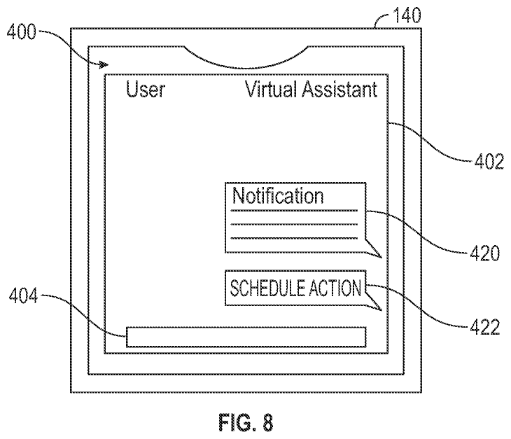

Referring now to FIG. 8, an illustration of a configuration of the user interface 400 on the user device 140 is shown. As illustrated, the user interface 400 includes the virtual assistant interface 402, the input actionable item 404, a notification element 420, and a notification actionable item 422. The notification element 420 may indicate a notification associated with a future interaction between the user and the virtual assistant that has not yet occurred. As illustrated, the notification element 420 is a text box that corresponds to the notification corresponding to the future interaction that has not yet occurred between the user and the virtual assistant. In some instances, the notification element 420 may include figures indicating the notification, elements indicating the notification, etc. For example, the notification element 420 may include text corresponding to a notification that is a reminder of a future interaction that has not yet occurred between the user and the virtual assistant based on a interaction frequency associated with the interactions between the user and the virtual assistant associated with the classification of the input and the prior user interaction such that the user may be reminded of the future interaction prior to the occurrence of the future interaction. As another example, the notification element 420 may include text corresponding to a notification that includes content associated with the future interaction that has not yet occurred based on the classification of the input and the prior user interaction. For example, if the input and the prior user interaction both relate to the user querying if a paycheck has been deposited in a bank account associated with the user, the notification element 420 may include a confirmation that the paycheck has been deposited in the bank account prior to the virtual assistant receiving another query from the user related to the paycheck.

The notification actionable item 422 may be associated with the notification associated with the future interaction between the user and the virtual assistant with the same classification as the input of the interaction and the prior user interaction. In some instances, the user may select the notification actionable item 422 to initiate an action corresponding to the prior resolution to the prior user interaction with the same classification as the future interaction. For example, in some instances, the notification actionable item 422 may allow for the processing circuit to initiate an action associated with the prior user interaction within an interaction period associated with the future interaction, such that the user may easily initiate the action prior to holding the future interaction with the virtual assistant.

It should be understood that no claim element herein is to be construed under the provisions of 35 U.S.C. § 112 (f) unless the element is expressly recited using the phrase “means for.”

As used herein, the term “circuitry” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory).

Alternatively, or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be provided as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud-based processor). Alternatively, or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud-based server). To that end, a “circuit” as described herein may include components that are distributed across one or more locations.

Example systems and devices in various embodiments might include a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick, or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the smart table system may be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described to explain the principals of the disclosure and its practical application to enable one skilled in the art to utilize the various embodiments and with various modifications as are suited to the particular use contemplated. Other substitutions, modifications, changes, and omissions may be made in the design, operating conditions, and arrangement of the embodiments without departing from the scope of the present disclosure as expressed in the appended claims.

What is claimed is:

1. A system comprising:
a processing circuit comprising memory and one or more processors, the processing circuit configured to:
receive an input from a user device associated with a user during an interaction with a virtual assistant executed by the processing circuit;
determine a classification associated with the input;
identify a prior user interaction with a virtual assistant associated with the classification;
determine a prior resolution based on the prior user interaction, wherein the prior resolution comprises an action available to the user;
determine, based on current financial data associated with the user and the prior resolution, if the action available to the user satisfies a threshold; and
generate and provide, based on the action available to the user satisfying the threshold, an output via the user device, the output corresponding to the prior resolution.

2. The system of claim 1, wherein the output comprises an interface via a graphical user interface (GUI) of the user device, the interface comprising an actionable item associated with the prior resolution; and
wherein the processing circuit is further configured to initiate the action available to the user based on a selection of the actionable item.

3. The system of claim 1, wherein the processing circuit is further configured to:
generate a recommended resolution based on the current financial data and the input, wherein the recommended resolution comprises a recommended action available to the user; and
generate and provide a recommendation output via the user device, the recommendation output corresponding to the recommended resolution.

4. The system of claim 3, wherein the processing circuit is further configured to:
determine prior decision components used to generate the prior resolution;
determine current decision components used to generate the recommended resolution;
compare at least one of the prior decision components and at least one of the current decision components; and
generate and provide a comparison output via the user device, the comparison output corresponding to the comparison of the at least one of the prior decision components and the at least one of the current decision components.

5. The system of claim 3, wherein the recommendation output comprises an interface via a graphical user interface (GUI) of the user device, the interface comprises an actionable item associated with the recommended resolution; and
wherein the processing circuit is further configured to initiate the recommended action of the recommended resolution based on a selection of the actionable item.

6. The system of claim 1, wherein the processing circuit is further configured to:
determine an interaction frequency associated with interactions between the user and the virtual assistant executed by the processing circuit and being associated with the classification;
determine, based on the input and the interaction frequency, an interaction period associated with a future predicted interaction between the user and the virtual assistant executed by the processing circuit associated with the classification; and
generate and provide a notification output via the user device, the notification output corresponding to a notification associated with the future predicted interaction.

7. The system of claim 6, wherein the notification output comprises an interface via a graphical user interface (GUI) of the user device, the interface comprises an actionable item associated with the prior resolution; and
wherein the processing circuit is further configured to initiate the action corresponding to the prior resolution within the interaction period based on a selection of the actionable item.

8. The system of claim 1, wherein the processing circuit is further configured to:
determine prior decision components used to generate the prior resolution; and
generate and provide a logic output via the user device, the logic output corresponding to the prior resolution and at least one of the prior decision components.

9. The system of claim 8, wherein the logic output comprises an actionable item associated with the at least one of the prior decision components; and
wherein in response to receiving an indication of an adjustment of the actionable item, the processing circuit is further configured to:
determine a decision adjustment of the at least one of the prior decision components corresponding to the adjustment of the actionable item;
generate, based on the decision adjustment, an updated resolution, wherein the updated resolution comprises an updated action available to the user;
generate and provide an updated resolution output via the user device, the updated resolution output corresponding to the updated action of the updated resolution.

10. A method comprising:
receiving, by a processing circuit, an input from a user device associated with a user during an interaction with a virtual assistant executed by the processing circuit;
determining, by the processing circuit, a classification associated with the input;
identifying, by the processing circuit, a prior user interaction with a virtual assistant associated with the classification;
determining, by the processing circuit, a prior resolution based on the prior user interaction, wherein the prior resolution comprises an action available to the user;
determining, by the processing circuit and based on current financial data associated with the user and the prior resolution, if the action available to the user satisfies a threshold; and
generating and providing, by the processing circuit and based on the action available to the user satisfying the threshold, an output via the user device, the output corresponding to the prior resolution.

11. The method of claim 10, wherein the output comprises an interface via a graphical user interface (GUI) of the user device, the interface comprises an actionable item associated with the prior resolution, and the method further comprises:
receiving, by the processing circuit, a selection of the actionable item from the user device; and
initiating, by the processing circuit and based on the selection of the actionable item, the action available to the user.

12. The method of claim 10, further comprising:
generating, by the processing circuit, a recommended resolution based on the current financial data and the input, wherein the recommended resolution comprises a recommended action available to the user; and
generating and providing, by the processing circuit, a recommendation output via the user device, the recommendation output corresponding to the recommended resolution.

13. The method of claim 12, further comprising:
determining, by the processing circuit, prior decision components used to generate the prior resolution;
determining, by the processing circuit, current decision components used to generate the recommended resolution;
comparing, by the processing circuit, at least one of the prior decision components and at least one of the current decision components; and
generating and providing, by the processing circuit, a comparison output via the user device, the comparison output corresponding to the comparison of the at least one of the prior decision components and the at least one of the current decision components.

14. The method of claim 12, wherein the recommendation output comprises an interface via a graphical user interface (GUI) of the user device, the interface comprises an actionable item associated with the recommended resolution, and the method further comprises:
receiving, by the processing circuit, a selection of the actionable item from the user device; and
initiating, by the processing circuit and based on receiving the section of the actional item, the recommended action of the recommended resolution.

15. The method of claim 10, further comprising:
determining, by the processing circuit, an interaction frequency associated with interactions between the user and the virtual assistant executed by the processing circuit and being associated with the classification;
determining, by the processing circuit and based on the input and the interaction frequency, an interaction period associated with a future predicted interaction between the user and the virtual assistant executed by the processing circuit associated with the classification; and
generating and providing, by the processing circuit, a notification output via the user device, the notification output corresponding to a notification associated with the future predicted interaction.

16. The method of claim 10, further comprising:
determining, by the processing circuit, prior decision components used to generate the prior resolution; and
generating and providing, by the processing circuit, a logic output via the user device, the logic output corresponding to the prior resolution and at least one of the prior decision components.

17. The method of claim 16, wherein the logic output comprises an actionable item associated with the at least one of the prior decision components, and the method further comprises:
receiving, by the processing circuit, an indication of an adjustment of the actionable item from the user device;
determining, by the processing circuit, a decision adjustment of the at least one of the prior decision components corresponding to the adjustment of the actionable item;
generating, by the processing circuit and based on the decision adjustment, an updated resolution, wherein the updated resolution comprises an updated action available to the user; and
generating and providing, by the processing circuit, an updated resolution output via the user device, the updated resolution output corresponding to the updated action of the updated resolution.

18. A non-transitory computer-readable storage medium having instructions stored thereon that, when executed by at least one processing circuit, cause the at least one processing circuit to perform operations comprising:
receiving an input from a user device associated with a user during an interaction with a virtual assistant executed by the at least one processing circuit;
determining a classification associated with the input;
identifying a prior user interaction with a virtual assistant associated with the classification;
determining a prior resolution based on the prior user interaction, wherein the prior resolution comprises an action available to the user;
determining, based on current financial data associated with the user and the prior resolution, if the action available to the user satisfies a threshold; and
generating and providing, based on the action available to the user satisfying the threshold, an output via the user device, the output corresponding to the prior resolution.

19. The non-transitory computer-readable storage medium of claim 18, the operations further comprising:
generating a recommended resolution based on the current financial data and the input, wherein the recommended resolution comprises a recommended action available to the user; and
generating and providing a recommendation output via the user device, the recommendation output corresponding to the recommended resolution.

20. The non-transitory computer-readable storage medium of claim 19, wherein the operations further comprise:
determining prior decision components used to generate the prior resolution;
determining current decision components used to generate the recommended resolution;
comparing at least one of the prior decision components and at least one of the current decision components; and
generating and providing a comparison output via the user device, the comparison output corresponding to the comparison of the at least one of the prior decision components and the at least one of the current decision components.
